(19) United States
(12) Patent Application Publication
(10) Pub. No.: US 2004/0121629 A1
(43) Pub. Date: Jun. 24, 2004

(54) Circuit board mounted electical connector

(76) Inventor: Sun Zhao You, Shanghai (CN)

Correspondence Address: MOLEX INCORPORATED, 2222 WELLINGTON COURT, LISLE, IL, 60532, US

(21) Appl. No.: 10/706,264

(22) Filed: Nov. 12, 2003

(30) Foreign Application Priority Data
Nov. 15, 2002 (TW) 091218512

(51) Int. Cl. H01R 12/00

(52) U.S. Cl. 439/66

(57) ABSTRACT

An electronic card connector comprises an insulating housing, a plurality of conductive terminals, and a plurality of terminal passageways penetrating the insulating housing from its top to its bottom. The conductive terminals can be respectively received in corresponding terminal passageways. In addition to a base portion, each conductive terminal comprises a soldering tail and a contact portion, and they are disposed at the opposite ends of the conductive terminal respectively. Accepting recesses are formed at the bottom of the insulating housing to receive the soldering tail. Interference portions designed to hold the soldering tails are formed on the inner walls of the accepting recesses. An elevated platform is formed in the middle of each accepting recess for being pressed against by the soldering tail. An approximately U-shaped slot is formed in between two neighboring accepting recesses to enhance the holding strength of the interference portion to the soldering tail.

### BACKGROUND OF THE INVENTION

(A) Field of the Invention

The present invention is related to an electronic card connector, more specifically, to an electronic card connector installed inside a communication equipment, such as a cellular phone, to be connected to a corresponding identification card, for example, a SIM card.

(B) Description of the Related Art

With respect to the existing technology about electronic card connectors, please refer to Chinese patent application No. 99125707 and Taiwanese patent application Nos. 85205010 and 86212738. Such electronic card connectors comprise an insulating housing, a plurality of conductive terminals and a plurality of terminal passageways, which penetrate the insulating housing from the top to the bottom. In the shape of a bent plate, each conductive terminal is pushed into a corresponding terminal passageway from the bottom of the insulating housing.

Normally, the conductive terminal comprises a base portion, a soldering tail which extends from the base portion, a connecting portion which bends and extends from the other end of the base portion, a contact portion which extends from the connecting portion, and a plurality of interference body formed on the base portion to hold a conductive terminal in a terminal passageway. The electronic card connector is soldered to a circuit board through the soldering tail and connected to an identification card through the contact portion.

As shown in FIGS. 7 and 8, existing electronic card connectors are designed in such a way that a conductive terminal 71 is held in a terminal passageway 72 through an interference body 712 of a base portion 711, whereas the insulating housing 70 itself is not equipped with any interference portion to specifically hold the soldering tail 713. The insulating housing 70 will expand when being heated up, whenever the electronic card connector is soldered onto a circuit board. However, when being soldered onto the circuit board, the soldering tail 713 does not follow to alter its own shape. So, the holding force provided by the interference body 712 of the base 711 is insufficient to prevent the insulating housing 70 from deforming and bending upward. As a result, the soldering tail 713 is separated from the insulating housing 70, and thus affects the performance of the electronic card connector.

### SUMMARY OF THE INVENTION

In order to solve the problems above, the present invention improves the existing electronic card connectors to put forth an electronic card connector having conductive terminals more firmly held.

The electronic card connector provided by the present invention comprises an insulating housing with a top and a bottom, a plurality of conductive terminals, and a plurality of terminal passageways penetrating from the top of the insulating housing to its bottom; the conductive terminals are received in the corresponding terminal passageways. Each conductive terminal is approximately U-shaped, and comprises a base portion, a soldering tail extending from one end of the base portion, a connecting portion bending and extending from the other end of the base portion, and a contact portion extending from the connecting portion. The base portion is provided with at least one interference body. A plurality of accepting recesses are formed at the bottom of the insulating housing to receive the soldering tail. An interference portion designed to hold the soldering tail is formed on at least one of the inner walls of the accepting recess. The interference portion is shaped approximately as a semi-cylinder.

An elevated platform is formed in the middle of the accepting recess. The elevated platform is lower than the interference portion, inducing the soldering tailor and the bottom of the insulating housing to be on the same plane whenever the conductive terminal is received in the corresponding terminal passageway. A U-shaped slot may be formed between two neighboring accepting recesses to enhance the interference effect of the interference portion.

In order to reinforce holding for the entire terminal, the base portion of the conductive terminal is provided with at least one wing, and at least one holding hole is formed on both sides of the terminal passageway on the bottom of the insulating housing to hold the corresponding wing.

In the meanwhile, to prevent the terminals from deformation, a resistance portion shaped as a traverse rod extends from the front of the contact portion, and a blockade portion is formed inside the part of a terminal passageway near the top of the insulating housing. The blockade portion precisely presses against the resistance portion of the conductive terminal whenever the contact portion is pushed into the corresponding terminal passageway, which occurs when the electronic card connector is connected with an identification card.

The benefits of the present invention are as follows. The soldering tail of the conductive terminal is effectively held. The bonding stability between the conductive terminal and the insulating housing is enhanced. The disconnection of the soldering tail from the insulating housing due to the heat-induced expansion of the latter is prevented to ensure the performance of the electronic card connector.

### BRIEF DESCRIPTION OF THE DRAWINGS

FIG. 1 is a three-dimensional view of a preferred embodiment according to the present invention;

FIG. 2 is a cross-sectional view taken along line A-A of FIG. 1;

FIG. 3 is a three-dimensional view showing the disassembled parts of the structure of the preferred embodiment depicted in FIG. 1;

FIG. 4 is a three-dimensional view of the preferred embodiment depicted in FIG. 1 but observed from another angle after a conductive terminal has been removed therefrom;

FIG. 5 is a magnified inset derived from FIG. 4;

FIG. 6 is a three-dimensional view of the conductive terminal of the preferred embodiment depicted in FIG. 1;

FIG. 7 is a three-dimensional schematic view of a prior art electronic card connector after a conductive terminal has been removed therefrom; and

FIG. 8 is a magnified inset derived from FIG. 7.

### DETAILED DESCRIPTION OF THE INVENTION

The following description, associated with the attached drawings, is intended to illustrate a preferred embodiment of the present invention.

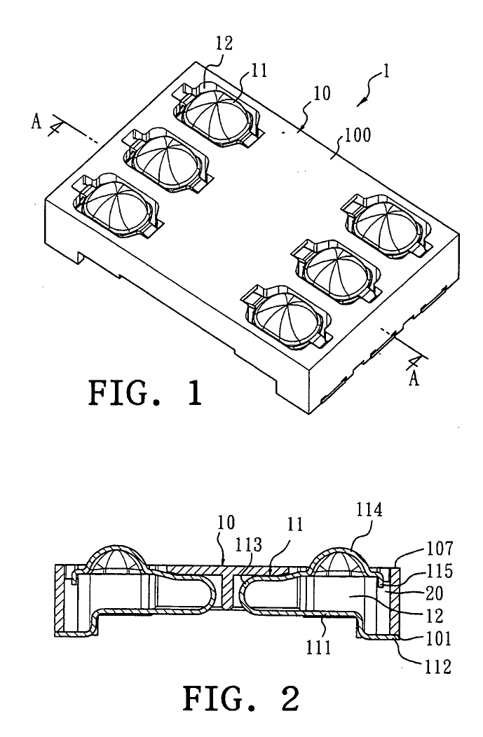

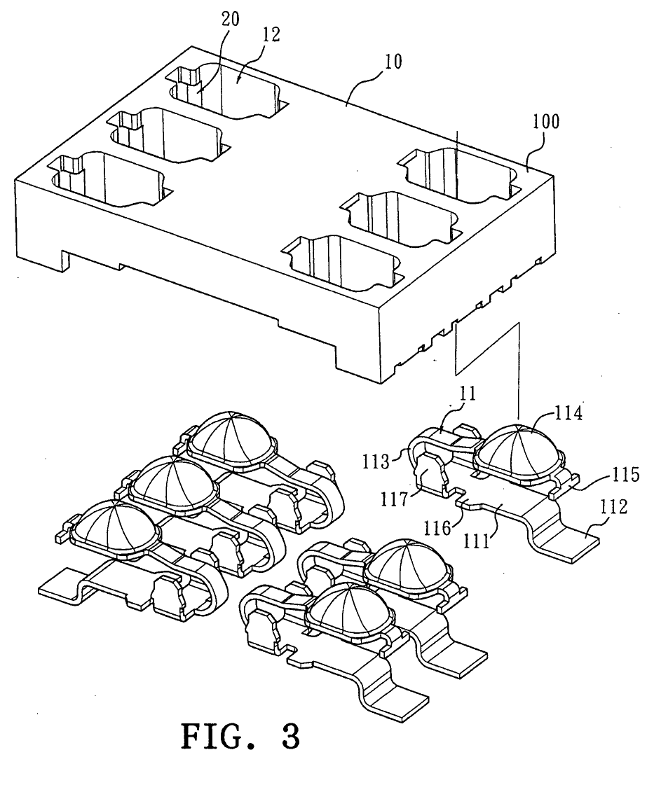

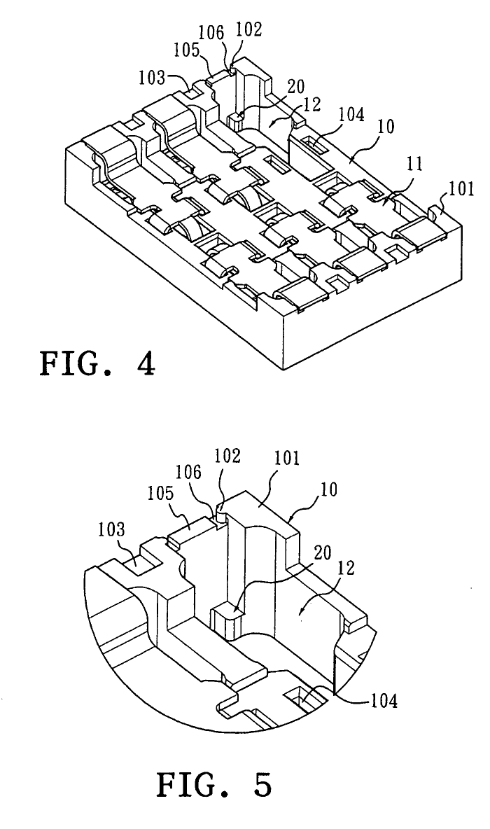

As shown in FIGS. 1 through 4, an electronic card connector 1 essentially comprises an insulating housing 10 having a top 100 and a bottom 101 oppositely disposed, a plurality of approximately U-shaped conductive terminals 11 and a plurality of terminal passageways 12 penetrating the insulating housing from the top 100 of the insulating housing 10 to its bottom 101. The conductive terminals 11 are being held in the corresponding terminal passageways 12 respectively.

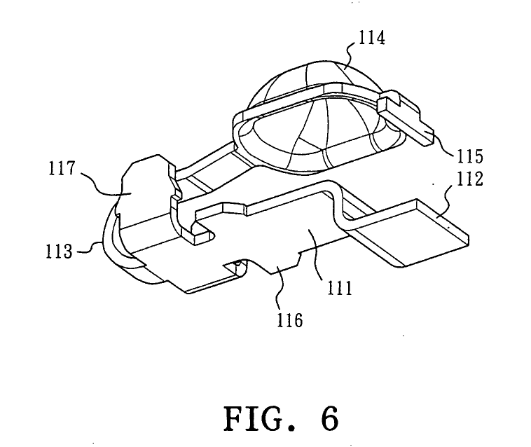

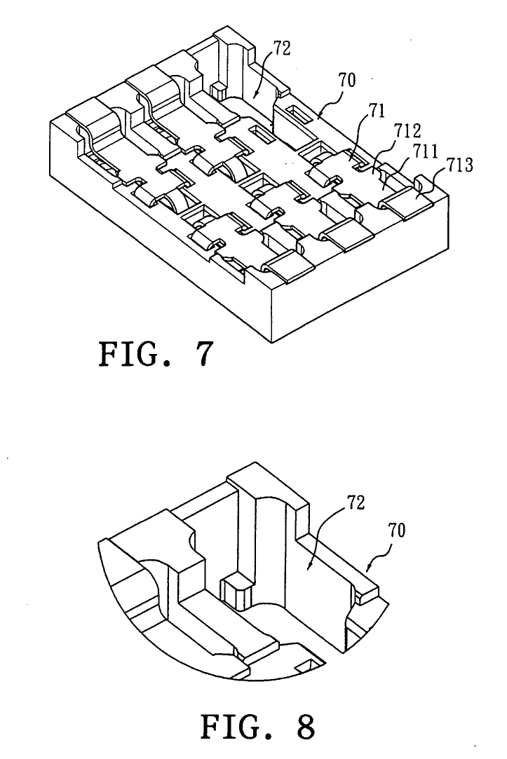

As shown in FIGS. 2, 3 and 6, each conductive terminal 11 comprises a base portion 111 equipped with two interference bodies 116 and two wings 117 (the interference bodies 116 horizontally extending outward from the base portion 111 whereas the wings 117 extend from the base portion 111 vertically), a soldering tail 112 extending from one end of the base portion 111, a connecting portion 113 bending and extending from the other end of the base portion 111, a contact portion 114 extending from the connecting portion 113, and a resistance portion 115 shaped as a traverse rod extending from the front of the contact portion 114.

As shown in FIGS. 2 through 5, a blockade portion 20 is formed inside the part of the terminal passageway 12 near the top 100 of the insulating housing 10. The contact portion 114 of the conductive terminal 11 is pushed into the corresponding terminal passageway 12 whenever the electronic card connector 1 is connected to an identification card. As a result, the blockade member 20 precisely leans against the resistance portion 115 of the conductive terminal 11 so as to prevent the deformation of the conductive terminal 11.

An accepting recess 106 is formed at the bottom 101 of the insulating housing 10 to hold the soldering tail 112 of the conductive terminal 11. The bottom 101 beside each side of the terminal passageway 12 is equipped with a holding hole 104 to match the corresponding wings 117 of the conductive terminal 11. Accordingly, the wings 117 are held inside the corresponding holding holes 104 so that the conductive terminal 11 can be held more firmly. Both sides of the inner walls of each accepting recess 106 are each equipped with an interference portion 102 shaped as a semi-cylinder. The interference portions 102 horizontally stick out from the inner walls of the accepting recesses 106 so as to hold the soldering tail 112. An elevated platform 105 is formed in the middle of each accepting recess 106 for being pressed against by the soldering tail 112.

When installing the conductive terminal 11, the conductive terminal 11 is pushed into the corresponding terminal passageway 12 from the bottom 101 of the insulating housing 10, inducing the wings 117 to be held inside the corresponding holding holes 104, and the soldering tail 112 presses against the elevated platform 105 and is held inside the accepting recess 106 by the interference portion 102. The interference body 116 precisely presses against the sidewall of the terminal passageway 12. The elevated platform 105 is lower than the interference portion 102 so as to ensure that both the soldering tail 112 and the bottom 101 of the insulating housing 10 are on the same plane.

It is preferential that another U-shaped slot 103 is formed at the bottom of the insulating housing 10 between two accepting recesses 106, so as to increase the elasticity of the interference portion 102 with a view to hold the conductive terminal 11 more firmly.

The above-described embodiments of the present invention are intended to be illustrative only. Numerous alternative embodiments may be devised by those skilled in the art without departing from the scope of the following claims.

What is claimed is:

1. An electronic card connector, comprising:
an insulating housing having a top and a bottom;
a plurality of terminal passageways penetrating from the top to the bottom of the insulating housing;
a plurality of conductive terminals received in the corresponding terminal passageways, and each conductive terminal including:
a base portion provided with at least one interference body;
a soldering tail extending from one end of the base portion;
a connecting portion bending and extending from the other end of the base portion; and
a contact portion extending from the connecting portion;
wherein the bottom of the insulating housing has a plurality of accepting recesses for receiving the soldering tail, and at lease one side of inner walls of the accepting recess has an interference portion for holding the soldering tail.

2. The electronic card connector in accordance with claim 1, wherein the interference portion is shaped as a semi-cylinder, and horizontally extends from the inner wall of the accepting recess.

3. The electronic card connector in accordance with claim 1, wherein the middle of the accepting recess is provided with an elevated platform for being pressed against by the soldering tail.

4. The electronic card connector in accordance with claim 3, wherein the elevated platform is lower than the interference portion, inducing the soldering tail and the bottom of the insulating housing to be on the same plane whenever the conductive terminal is installed into the terminal passageway.

5. The electronic card connector in accordance with claim 1, wherein a substantially U-shaped slot is formed between two neighboring accepting recesses on the bottom of the insulating housing.

6. The electronic card connector in accordance with claim 1, wherein at least one wing vertically extends from the base of the conductive terminal, and at least one holding hole is formed on the bottom of the insulating housing beside the terminal passageway for holding the at least one wing.

7. The electronic card connector in accordance with claim 1, wherein the interference body formed in the base of the conductive terminal horizontally extends outward from the base, whose width enables the conductive terminal to be precisely held in the terminal passageway.

8. The electronic card connector in accordance with claim 1, wherein a resistance member shaped as a traverse rod extends from the front of the contact portion, a blockade member is formed inside the part of the terminal passageway near the top of the insulating housing, and the blockade member precisely presses against the resistance member whenever the contact portion is pushed into the corresponding terminal passageway.

9. The electronic card connector in accordance with claim 1, wherein the conductive terminal is substantially U-shaped.
